(19) United States
(12) Patent Application Publication
(10) Pub. No.: US 2002/0169706 A1
(43) Pub. Date: Nov. 14, 2002

(54) Apparatus and methods for providing secure electronic brokers

(75) Inventors: Tushar D. Chandra, San Jose, CA (US); James T. Sherry, New York, NY (US); Charles P. Tresser, New York, NY (US); Paula K. Austel, Cortlandt Manor, NY (US); Ronald Perez, Mt. Kisco, NY (US); Sean William Smith, Hanover, NH (US)

Correspondence Address: Carstens, Yee and Cahoon, L.L.P., P.O. Box 802334, Dallas, TX, 75380, US

(73) Assignee: International Business Machines Corporation, Armonk, NY (US)

(21) Appl. No.: 09/852,934

(22) Filed: May 10, 2001

(51) Int. Cl. G06F 17/60

(52) U.S. Cl. 705/37

(57) ABSTRACT

Apparatus and methods for providing secure electronic brokers are provided. The apparatus and methods make use of trading programs and their matching rules (and if needed some negotiation protocols) which allows the apparatus to communicate with customers using messaging middleware, thereby becoming an electronic broker or e-broker for the customers. The e-broker device publishes, using Pub/Sub messaging technology, for example, the type of trades it expects to broker. Potential users subscribe, using content based matching, to the types of trades they would like to make. Together with its advertising, the e-broker publishes the public part of its public encryption scheme. The user then sends it encrypted bids and the public part of its own public encryption scheme to the e-broker. When the users submit their identification, the e-broker device checks their overall quality (credit, reputation, etc.). In some cases, once a bid is put by some initial bidder, the e-broker will publish the sort of matching bid it seeks in a way which does not compromise the interests of the first bidder, possibly after getting approval from the initial bidder on the message to be published. In some cases, possibly after negotiation, an e-broker may simply create a contact between matching bidders. In other cases, matching is binding for the deal to be made.

### 1. TECHNICAL FIELD

The present invention is directed to an improved distributed computer system. More particularly, the present invention is directed to apparatus and methods for providing secure electronic brokers for credit and trading.

### 2. DESCRIPTION OF THE RELATED ART

The past few years have been marked by the rapid development of electronic commerce (or e-commerce). One aspect of the emerging electronic commerce environment, made possible by the Internet, is that of establishing services for providing credit and trading brokerage. The credit brokerage, such as LendingTree.com™, typically includes an on-line application through which a user enters personal information which is then used by credit extending entities to determine the credit-worthiness of the user. The credit extending entities may then bid for the opportunity to provide the user with the desired credit. Similarly, the trading brokerage, such as Ebay™ or Ameritrade™, requires that the user to enter personal information and, in some instances, undergo a verification process in order to be able to engage in on-line trading. In any case, known automated systems require that the identification of the parties be made public prior to the trade being completed. This may be very undesirable in certain types of industries and in certain types of trades.

Thus, it would be beneficial to have an apparatus and method for maintaining the confidentiality of potential parties to a trade while maintaining security and fairness of the trade. It would also be beneficial to have an apparatus and method for maintaining the confidentiality of the transactions, both in cases when the identity can or should not be disclosed.

### SUMMARY OF THE INVENTION

The present invention provides apparatus and methods for providing secure electronic brokers. The apparatus and methods make use of trading programs and their matching rules (and if needed some negotiation protocols) which allow the apparatus of the present invention to communicate with customers using messaging middleware, thereby becoming an electronic broker or e-broker for the customers. The e-broker device publishes, using Pub/Sub messaging technology, for example, the type of trades it expects to broker (one or several forms of trades per broker, or different types of trades depending, e.g., on the time in the day—Japanese preferred deals and American preferred deals for instance).

A basic ingredient of the present invention is to write the trading programs with their matching rules, and if needed some negotiation protocols, in a secure coprocessor, such as the IBM 4758 PCI Cryptographic Coprocessor, for example. The e-broker devices need to be safe from physical and logical attacks. Making the device withstand all such attacks may not be practical or possible in all situations, so it is important that these devices have the ability to sense and respond to an imminent or ongoing attack by destroying any information (e.g. cryptographic keys, private/personal information, etc.) which might be misused by the attacker should they gain access to such information via a successful attack. Such a device may have the properties of the IBM 4758; a tamper-resistant, tamper-sensing, and tamper-responding device, which has been validated at the highest level of security assurance as prescribed in the Federal Information Processing Standard #140-1 (FIPS 140-1). The e-broker device is preferably field re-programmable and thus, the offerings of an e-broker device may vary depending on demands of the market.

Potential users subscribe, using content based matching, to the types of trades they would like to make. Together with its advertising, the e-broker device publishes the public part of its public encryption scheme. The user User1 then sends it encrypted bids and the public part of its own public encryption scheme to the e-broker. When the users submit their identification, the e-broker device checks their overall quality (credit, reputation, etc.). In some cases (e.g., for credit brokerage or big block trading), once a bid is put by some initial bidder, the e-broker will publish the sort of matching bid it seeks in a way which does not compromise the interests of the first bidder (precise nature of initial bid, identity of initial bidder, and the like), possibly after getting approval from the initial bidder on the message to be published.

In some cases, possibly after negotiation, an e-broker device simply creates a contact between matching bidders. In some other cases, matching is binding for the deal to be made. For the sake of fairness and/or regulatory compliance, and/or its own competitive advantage, the e-broker device makes available its matching rules, negotiations schemes, if any, closing mechanisms, pricing-method of payment, and the like.

Typically, an e-broker device will be hosted by a firm which will guarantee that no external or internal attack has been made on its e-broker device, and keep published the list of valid keys. Other parts of authentication will be done for instance using commercially available Certificate Authority.

On the network allowing access to the e-broker devices, other e-broker devices can be scattered near entry points to allow nearly geography-independent time stamping if required by regulation or to attract remote customers. To avoid information being disclosed by simple traffic eavesdropping, messages can be grouped and redistributed after proper message transforms and encryption at some nodes of the network (encrypted routers), which needs further cryptographic capabilities. Other features and advantages of the present invention will be described in, or will be apparent to those of ordinary skill in the art in view of, the following detailed description of the preferred embodiments.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1A is an exemplary block diagram illustrating a network data processing system according to one embodiment of the present invention;

FIG. 1B is an exemplary block diagram illustrating a network data processing system according to another exemplary embodiment of the present invention;

FIG. 2 is an exemplary block diagram illustrating a server device according to one embodiment of the present invention;

FIG. 3 is an exemplary block diagram illustrating a client device according to one embodiment of the present invention;

FIG. 4 is an exemplary block diagram illustrating the initialization of an e-broker device according to one embodiment of the present invention;

FIG. 5 is an exemplary block diagram illustrating a data flow according to the present invention; and

FIG. 6 is a flowchart outlining an exemplary operation of the present invention.

### DETAILED DESCRIPTION OF THE PREFERRED EMBODIMENT

As in previous forms of commerce, electronic commerce (e-commerce) often requires some form of brokering. The overall purpose of the present invention is to provide means to create electronic brokers that can be used in a variety of contexts.

At the turn of the millennium, several Business to Business electronic markets (B2B e-markets) are being created where businesses can deal with procurement and sale more efficiently than ever before. For such B2B electronic markets (e-markets) to be liquidity providers, they must be electronically well linked to financial services, such as payment, insurance, credit checking, clearing, and credit trading. Typically, a factory, say Fact, may need to build some infrastructure to either win a bid, deliver on time, or build on the momentum brought by the successful sale. Fact may not wish everyone to know it is seeking credit, however.

Fact can ask a broker (called a credit broker) to find one or several appropriate lenders. Fact contacts theses credit brokers successively in order of decreasing preference, according to some case dependent criteria (the broker can also get more involved in the negotiation). Of course, the potential lenders may like to know in advance if Fact is a business to which they want to lend money so that, by the time Fact and one of those potential lenders get to deal openly (directly or not) with each other, they both expect the deal to have a reasonably high probability of being completed. However, the borrower, i.e. Fact, may not want to reveal its position in the market to all those lenders.

The present invention enables credit seekers to retain their anonymity until they find an appropriate lender without requiring an intervening human broker. The present invention also enables all contacts to be made with near simultaneity (a key component of these transactions) rather than sequentially.

In order to provide an electronic broker that allows for private, simultaneous, and secure trading transactions over a network, such as the World Wide Web or the Internet, the following criteria should be met:

The communication with the electronic broker (for credit or security trading) as well as the broker itself needs to be particularly secure;

1. There must be very high confidentiality about the nature of the deals being made, as well as about the parties that make or seek deals;

2. The fairness of the processes has to be demonstrated, be credible, and be verifiable, in particular to regulating authorities;

3. The electronic infrastructure that supports the online operation (credit or trading) has to be fault tolerant, with a very minute expectation of down time depending on the business;

4. The operation must be scalable to face high volumes of transactions, and even more to provide real time quotes, in some circumstances;

5. The electronic brokers should, as much as possible, offer services comparable to those offered by human agents; and

6. The price of creating new electronic brokers should be reasonably low as one expects the needs for different kinds of electronic brokering to increase dramatically.

The present invention provides a mechanism for providing electronic brokers that satisfies each of the criteria set forth above. More generally, the present invention is useful for developing all forms of brokerage which necessitate privacy, secrecy, high volume, strict regulations, or any subset of the above. A non-exhaustive list of such forms of brokerage includes complex derivative securities, big block trading, swapping of debts, art and other forms of collectibles, commodities, high-value real estate, bandwidth, carbon credits, electricity, and the like. The price and practicality of the installation may indeed make the present invention appealing to less critical sorts of trade.

The following description of the present invention will include references to the sending and receiving of messages amongst a plurality of devices. The messaging functions of this invention may be performed, for example, by messaging middleware or the like. Messaging middleware is presently sold by several companies including TIBCO (e.g., the TIB Rendez Vous™ products) and IBM (with a variety of MQ products, and the newly created technology for Pub/Sub on the Internet, known as Gryphon™). Messaging middleware comes in various forms, with a variety of properties, including guaranteed delivery, message transformation, WAN (Wide Area Network) or LAN (Local Area Network) compatibility, various levels of security support, various levels of scalability properties, and the like.

Also supported by some messaging middleware is the Pub/Sub (Publish and Subscribe) multicast capability. With the Pub/Sub multicast capability, an emitting party publishes a variety of messages and potential receiving parties declare the sort of those messages they want to receive. The Pub/Sub system matches each published message with the interests of subscribers to determine which subscribers should receive that message. Matching can be done by the subject of a message, as in some TIBCO™ products, or more conveniently by the content of a message, as in Gryphon™.

The messages sent by the messaging middleware may be encrypted, as described in more detail hereafter, using cryptographic capabilities of the electronic brokerage devices of the present invention. The cryptographic functions of the present invention may take various forms and may include, for example, the use of Private key/public key pairs (or SK/PK pairs; also referred to as public schemes), digital signature cryptographic schemes such as secret encoding keys or secure hash functions (such as SHA-1, as fully specified in the Federal Information Processing Standard Publication 180-1), or the like, as is generally known in the art.

A digital signature cryptographic scheme may be used in the form of a pair of functions Sign and Sign⁻¹ which are inverses of each other, i.e., for a plain text X to be signed, Sign⁻¹ (Sign (X))=X. The functions Sign and Sign⁻¹ are known publicly. The key of Sign is kept secret, being known only to a legitimate owner of the signature and its agents. The key of Sign⁻¹ is known publicly, and accessible for instance through the World Wide Web, through an agency, or given away by the owner of the pair to whoever needs to check the identity of the sender and/or that a message is exactly as the owner intended it to be. The key of Sign cannot be computed from the (public) key of Sign⁻¹.

A public encryption scheme may be in the form of a pair of functions Encr and Encr⁻¹ which are inverses of each other, i.e., for a plain text X to be encrypted, Encr⁻¹ (Encr (X))=X. The functions Encr and Encr⁻¹ are known publicly. The key of Encr⁻¹ is kept secret, being know only to the legitimate owner of the encryption scheme and its agents. The key of Encr is known publicly, and accessible for instance through the World Wide Web or through some agency specializing in providing PKI, or given away by the owner of the pair to whoever wants to send the owner a secret message, or keep secret some part of the message. The key of Encr⁻¹ cannot be computed from the (public) key of Encr.

As a message may contain much more information than the length of the keys, several methods can be used, possibly concurrently as is well known in the art. For instance, one can split the message in several pieces, some or all of which will be signed, one can compress the information, for instance using a secure hash function, or one can select a subset of the information. Clearly, the protocol which is chosen has to be known publicly if one desires to use public key cryptography. Also notice that, even if one wishes to use the benefits of public key cryptography, it may be useful to also hide secret information in the messages, so that one could recognize that someone has succeeded in breaking the keys being used. As usual in the art, it is advisable to change the keys being used every so often, depending on the application, and to keep a list of former keys.

With reference now to the figures, a detailed description of the present invention will be provided with regard to a first implementation directed to a credit brokerage system, a second implementation directed to a block trading system, and a third implementation directed to a high volume trading system. While the present invention will be described with reference to these particular implementations of the invention, the present invention is not limited to only these exemplary implementations. Rather the present invention is applicable to providing brokerage systems for all types of brokerage and is not limited in its applicability.

For the ease of description, the terms “processor” and “co-processor” as used herein are intended to mean a processor equipped with a co-processor. As is well known, a single processor can be equipped with several co-processors. By “secure processor” we mean either a genuine secure processor, or a regular processor equipped with one or a plurality of co-processors, one of which at least is a secure co-processor with virtues comparable to those of the IBM 4758 PCI Cryptographic Coprocessor.

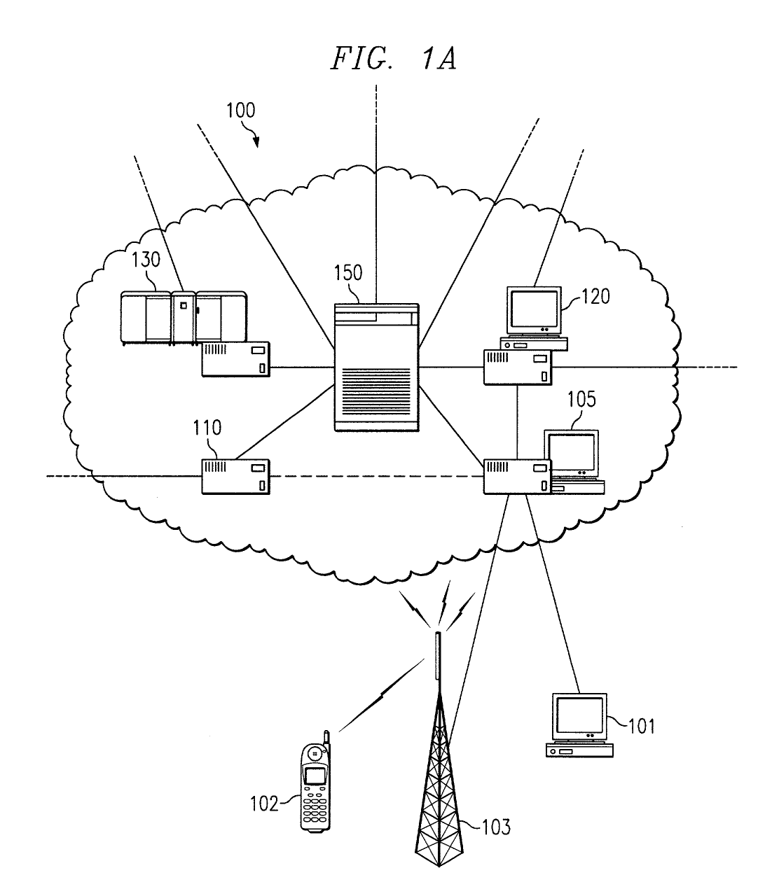

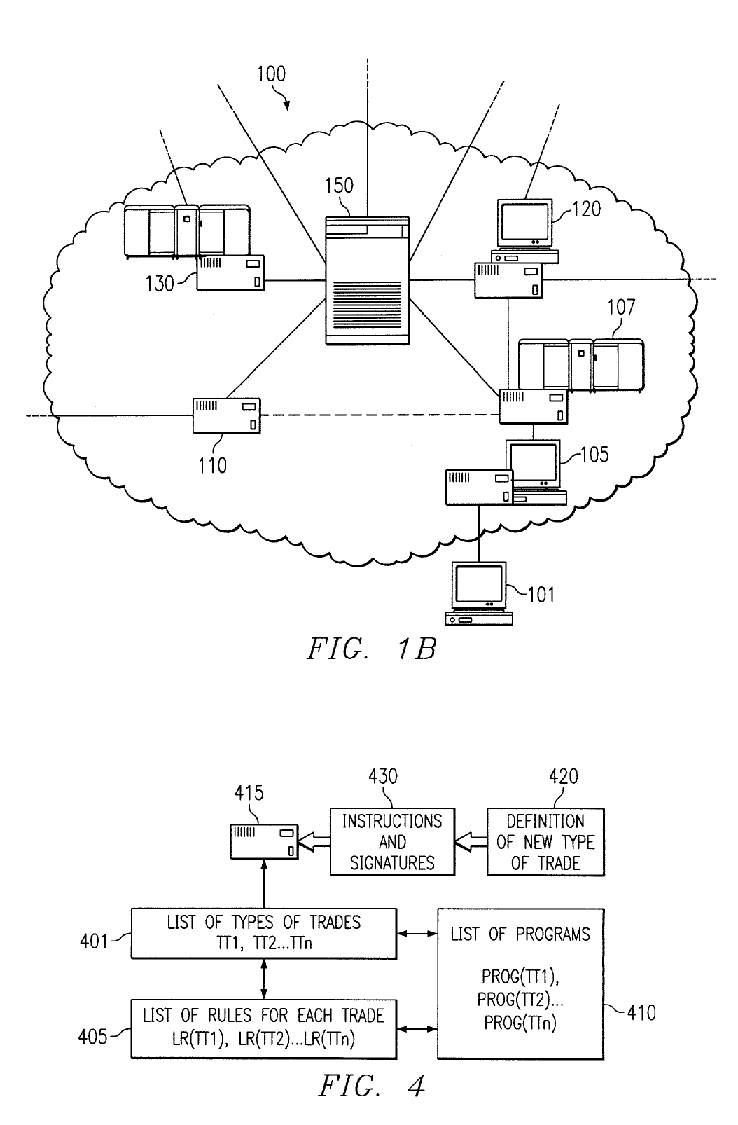

With reference now to FIG. 1A, a network data processing system 100 is depicted in which the present invention may be implemented. As shown in FIG. 1A, the network data processing system 100 includes a plurality of processors 105-130 coupled to a router 150. The processors 105-130 are preferably cryptographic processors, such as the IBM 4758 cryptographic coprocessor, or the like.

The IBM 4758 PCI cryptographic coprocessors (hereafter the “4758”) is a programmable, field upgradable piece of secure hardware. The 4758 performs high speed cryptographic operations, and provides secure key storage and is both cryptographically secure and able to detect and protect itself against physical attacks (probe, voltage, temperature, radiation). The 4758 is a secure coprocessor with a PCI bus interface, and is currently supported on a variety of platforms including WindowsNT, AIX, OS/2, Linux, Solaris, OS/390 and OS/400.

The typical uses of secure coprocessors, such as the 4758, include high speed, bulk cryptography, such as for digital movies, in-flight entertainment systems, secure databases, confidential video-conferences, telemedicine, telecommuting, and the like. The 4758 is also used to provide security in non-trusted environments for instance for smart card personalization, electronic currency dispensers, electronic benefits transfer, server-based smart card substitutes, home banking, certification authorities, secure database key control, e-postage meters, electronic payments, secret algorithms, secure time stamps, contest winner selection, software usage metering, electronic securities trading, hotel room gaming, secure voting, and the like.

While the present invention will be described in terms of a 4758 coprocessor being used to provide a specific implementation of the electronic broker, the present invention is not limited to this particular hardware. Rather, any processor or co-processor or device capable of providing the functionality herein described is intended to be within the spirit and scope of the present invention.

Returning to FIG. 1A, the processors 105-130 are preferably programmed to operate as electronic brokers (hereafter referred to as “e-brokers”) in accordance with the present invention as described hereafter. Different kinds of e-broker devices built according to this invention may coexist on the network data processing system 100, depending on the volume of transactions and overall volume of information and processing the e-broker devices have to handle. The processors 105-130 having been configured as e-brokers (hereafter referred to as e-broker devices) can operate by themselves, as in processor 110, in conjunction with a workstation or another small computer as in processor 120, or in conjunction with a mainframe as in processor 130. A set of processors may also be pooled to give the appearance of a single machine, for greater computing and memory capacities, for the sake of replicating sensitive and/or precious information, or the like.

Users can access e-broker devices 105-130 on the network data processing system 100 through a wired client device, such as client device 101, through wireless client devices, such as client device 102, or the like. The client devices (wired or wireless) may be, for example, personal computers, network computers, portable computers, personal digital assistants, Internet enabled cellular telephones, pagers, and the like. In a preferred embodiment, wired client device 101 is a personal computer and wireless client device 102 is an Internet enabled cellular telephone that communicates with the network data processing system 100 through base station 103.

The client devices may participate in, negotiate, and complete trades with other client devices, servers, or other network devices via one or more e-broker devices 105-130. In the present context, a trade is intended to include, for example, procurement of credit from a credit extending entity, security trades, trades of goods and/or services, obtaining a loan from a financial institution, and the like. Other types of trades not explicitly stated in the present description are intended to be within the spirit and scope of the present invention.

In some cases, time stamping stations can be scattered in the network data processing system 100 to allow for more fairness of competition amongst potential participants in a trade, as will be described in more detail hereafter. Such time stamping stations may be, for example, a stand alone processor, a processor in conjunction with more powerful computers, such as time stamping station processor 105, or other forms of machines. With the e-broker devices 105-130 of the present invention, security and anonymity are of paramount importance. In order to further increase the security of the e-broker devices 105-130 and the transmission to these e-broker devices 105-130 from client devices, encrypted routers, such as encrypted router 107 in FIG. 1B, may be used to group messages before redistribution in order to prevent eavesdroppers from guessing who deals with whom. The e-broker devices 105-130 may also be used for this purpose. Some client devices may also be allowed, or even invited, to send “bogus” messages to the network data processing system 100 to help protect against traffic analysis attacks.

To initiate a trade, an operator of the e-broker device sends a description of a trade that the e-broker device will next manage. This description consists of, for example, a list of acceptable parties to the trade (e.g., particular industries, companies, individuals), the type of trade being sought, and possibly also a list of required or preferable qualifications for performing the trade, such as a party's geographical location, assets, credit rating, and the like.

The e-broker device publishes the description of the trade it will next transact, together with cryptographic access methods, and identification of the e-broker device's owner and the methods the e-broker device will use to determine an appropriate counterparty to the trade. This may be done, for example, using Pub/Sub, posting on a web page or in a central repository, or the like.

Potential first parties to the trade that have the right qualifications receive the description of the trade. The potential first parties may be identified based on the parties being subscribers to the e-brokerage service, the parties having visited the web page (directly or using some specialized search engine), signed up and been approved for a service that posts the trades being managed by the e-broker device, or the like. One or more of the potential first parties may then respond to receipt of the description by returning a message indicating that they are willing to become involved in a trade of the type identified by the e-broker device.

The e-broker device then composes a description of a message, Mess1, it will broadcast to fetch counterparties willing to engage in the trade. For instance, this message can be composed only by deleting or omitting the name and address of the parties from the reply message sent from the parties. Optionally, the e-broker device may provide the parties themselves with the opportunity to review, edit and/or accept the message to be broadcast.

The e-broker device then publishes the message, Mess1, after correction if needed, using again a Pub/Sub infrastructure or simple message posting, again with cryptographic access methods and description of the owner and its methods. Potential counterparties to the trade may then send offers to become involved in the identified trade, possibly with extra requirements needing to be met by the first parties, to the e-broker device which may then pass the offers on to the first parties. Time stamping can be used to determine the priority of similar offers. The identity of the first parties, or certain aspects of the first parties' identities, is preserved until an acceptable counterparty is found. For example, the name, address, telephone number, and/or the type of business that a first party is in may be kept confidential. Alternatively, the identity of the first party, or certain aspects thereof, may have limited distribution by arranging that only declared potential counterparties will have access to a list of first parties after they declare their interest in becoming involved in the trade.

Thus, each party is only provided with information regarding other parties interested in the declared trade when both parties have declared their intentions to become involved in the trade. Prior to such a declaration, the only information each of the parties has is the identity of the e-broker device's owner, the type of trade being managed by the e-broker device, the criteria being used by the e-broker device, and the like. The parties are anonymous with regard to other potential parties to the trade until both have declared their intentions to trade.

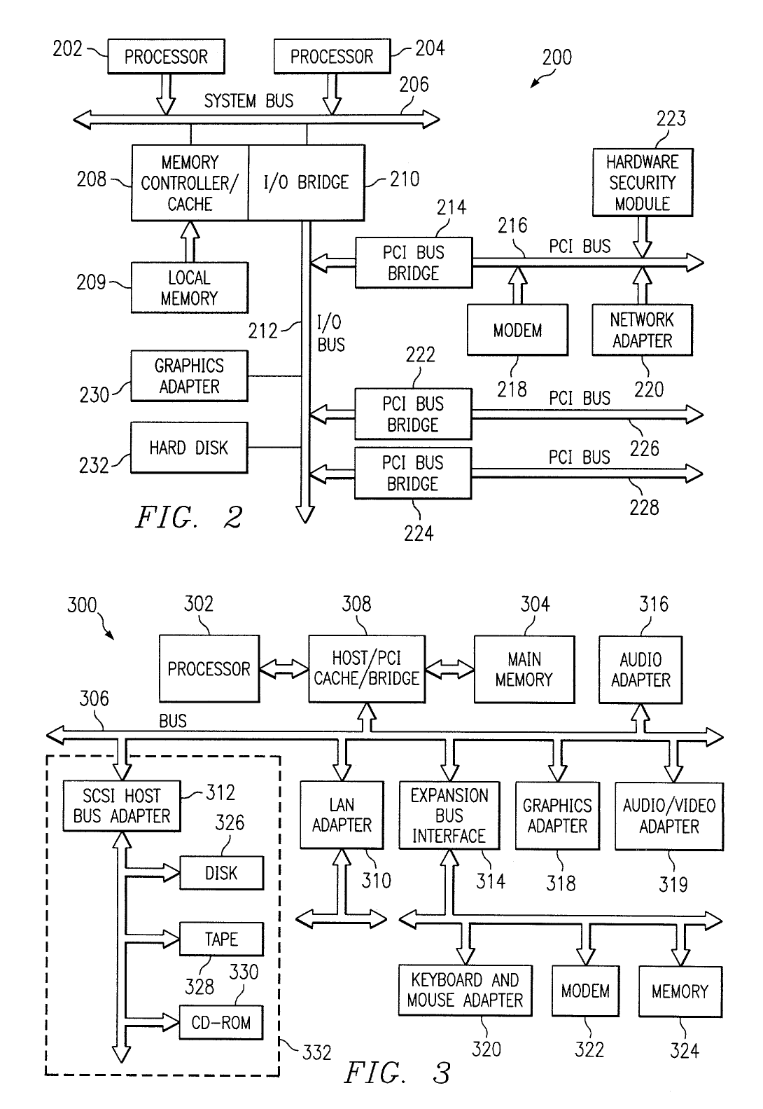

Referring to FIG. 2, a block diagram of a data processing system that may be implemented as an electronic broker, such as e-broker 120, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. One or more of the processors 202 and 204 may be utilized as an e-broker device in accordance with the present invention. Alternatively, the e-broker device may be external yet coupled to the device shown in FIG. 2.

Also connected to system bus 206 is memory controller/cache 208, which provides an interface to local memory 209. I/O bus bridge 210 is connected to system bus 206 and provides an interface to P/O bus 212. Memory controller/cache 208 and P/O bus bridge 210 may be integrated as depicted.

Peripheral component interconnect (PCI) bus bridge 214 connected to P/O bus 212 provides an interface to PCI local bus 216. A number of modems and other devices may be connected to PCI bus 216. Typical PCI bus implementations will support four PCI expansion slots or add-in connectors. Communications links to network computers 108-112 in FIGS. 1A and 1B may be provided through modem 218 and network adapter 220 connected to PCI local bus 216 through add-in boards.

In addition to modem 218 and network adapter 220, a hardware security module 222 is coupled to PCI local bus 216. The hardware security module 222 provides security mechanisms for securing communications to and from the data processing system 200. The hardware security module 222 may be, for example, a cryptographic coprocessor, such as IBM 4758 PCI Cryptographic Coprocessor. Furthermore, while FIG. 2 depicts the hardware security module 222 being coupled to the PCI local bus 216, the invention is not limited to such a configuration and the hardware security module 222 may be coupled to system bus 206, I/O bus 212, or the like.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM RISC/System 6000 system, a product of International Business Machines Corporation in Armonk, N.Y., running the Advanced Interactive Executive (AIX) operating system.

With reference now to FIG. 3, a block diagram of a data processing system that may be a client computer in accordance with the present invention is illustrated. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as FLASH ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or FLASH ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

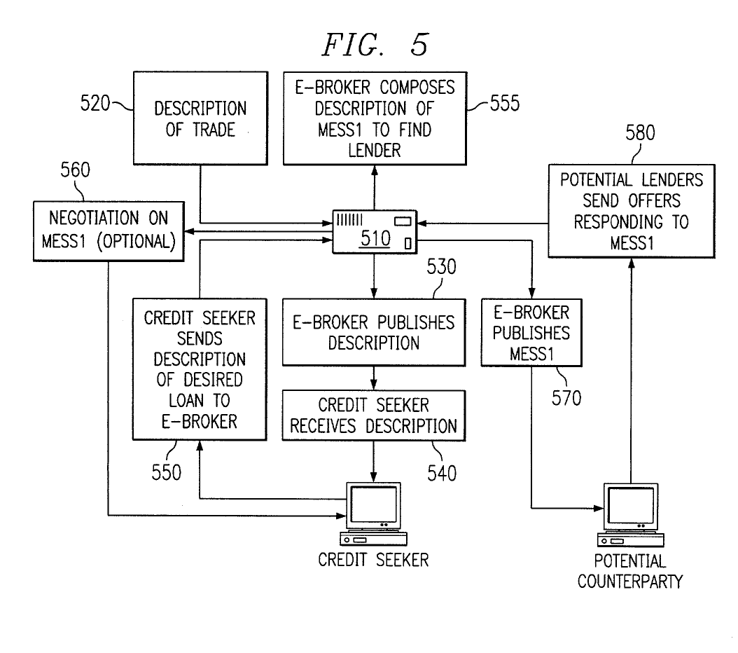

With reference now to FIG. 4, to initialize an e-broker, or an e-broker farm, a list 401 of types of trades TT1, TT2 . . . TTn that the e-broker(s) 415 will conduct is defined. As markets evolve, the types of trades being performed from this list may change. This may require secure implementation of new unscheduled types of trades and corresponding programs. With the present invention, however, the e-broker devices are field programmable and thus, the types of trades being handled by the e-brokers may be modified without having to modify the machines themselves. The manner by which this modification to the list of trade types can be performed without compromising security, and in particular confidentiality, will be described in greater detail hereafter.

Each type of trade TTi, i=1 . . . n has a corresponding list of rules LR (TTi) 405, including the matching method, negotiation scheme if any, and other sorts of description on how the e-brokers 415 will operate, and its program Prog (TTi) 410. All programs can be stored in a storage device associated with the e-broker 415, in a computer associated with the e-broker 415, or the like. The programs may further be stored in encrypted form in order to maintain security.

The e-broker 415 stores a signature of the programs in memory to prevent a hostile party from making the e-broker 415 accept a program that is not authorized. In some embodiments, the operating system running on the e-broker 415 may support segmentation, paging individual segments or pages may be moved between a host computer and the e-broker 415. In such embodiments, each segment or page may be encrypted or signed as appropriate. In general, program segments and pages may be stored in the “clear” while data segments and pages may be encrypted to conceal their content.

Either automatically, or through human intervention, one type of trade 420, is selected as the trade that will next be managed by the e-broker 415, possibly after fixing some parameters (e.g., the name of the security, or the size of the blocks, or the industry for which loans are to brokered, or the century the paintings were made, etc . . . ). This type of trade can be from the list of types already stored or a new trade, in which case, the list of trade types will be modified. Then at 430, if the selection of a trade is not performed automatically by the e-broker device, the owner or one of its agents sends this instruction to the e-broker 415, after proper signature. The e-broker 415 can then start a new brokerage operation.

The e-broker 415 is provided with the list of digital signatures of the programs which can provide it instructions, and in particular a master key that may be used to change the list of digital signatures. The instructions and types of messages that the e-broker 415 may accept, is strictly controlled in order to maintain security of the system.

To protect the system from ill-intentioned attempts to clog the e-broker 415, and avoid clogging by error, the e-broker device will only accept the types of trade, if any, which can run in conjunction with the trades that are still active in 401. In most cases only actual trades may be accepted as opposed to indications of interest or other approaches that would clog the system with unwanted messages. Any instruction to accept a trade, or any other instruction for that matter, must be properly signed with a recognized digital signature from the list of digital signatures for the e-broker 415 to execute the instruction.

The e-broker 415 will accept definitions of new types of trades from the owner of the e-broker device, agents of the owner, or other authorized users. To prevent authorized users, and in particular ill-intentioned employees, from getting information that should remain confidential, no queries to the e-broker 415 about the type of information entrusted to it is accepted. All executables must be one of the Prog (TTi) with the exception of a secure method being provided to run new programs. For example, one a priori secure method may be that the new programs carry proper several signatures, each only being known to a separate user. Thus, the users would be forced to collude in order to wrongfully obtain information, which is much less likely than an individual attempting to wrongfully obtain information.

The only other input that the e-broker 415 accepts must be one of a first kind of input, pertaining to elements of a trade, or of a second kind of input, pertaining to security measures of the trade, which are defined as follows:

First kind inputs may include:

1) requests from the owner for the full list of signatures of programs that the e-broker device may run for different trades, and to print the corresponding programs, all for verification purpose by the owner or regulatory authorities—the e-broker device will refuse such request while operating trades, and all trades will be stopped at some scheduled time for the possibility of verification;

2) offers of trades according to predetermined type of trade dependent formats;

3) information sheets (in particular credit ratings), according to predefined formats, and typically only in response to information requests sent by the e-broker device;

4) acceptances or rejections of offers made by the e-broker device when operating in a negotiation mode;

5) demands for change of offers if the original offer is not met (e.g., a customer may accept to sell half the shares it wanted to sell, only if it can buy some other block of shares); and

6) queries for mutual revelation of identity and contact information from parties that reached a match (in case of non-committing participation, but such non-committing bids may be exceptional), or from parties asking an almost matching party to finish the trade on another channel (both parties must agree before the e-broker device prompts the exchange of information).

Second kind inputs may include:

1) encrypted versions of customers' names after a match has been made using the e-broker device, as described below on high volume trade; and

2) other types of trade-specific security inputs including signature, encryption, and format being used so that the security of the e-brokers is protected, and published and available, in particular by regulatory authorities.

All messages to the e-broker device may be encrypted with a public part of an e-broker PK encryption scheme, for confidentiality purposes. Furthermore, all messages to the e-broker 415 must be properly signed for the sake of non-repudiation. Other message specific encryption schemes may be used in addition to, or in replacement of those described above depending on the particular embodiment and implementation.

Based on these various types of inputs, the e-broker 415 defines new types of trades, selects a type of trade that is next to be managed, receives inputs from client devices identifying the terms of trades that they wish to make, matches client devices based on their willingness to become involved in a trade, and provides matching parties with information to complete a trade. All of these functions are performed in a secure and anonymous manner with regard to the parties involved in the trade and agents of the owner of the e-broker device.

As mentioned above, the e-broker 415 matches parties interested in a trade in an anonymous fashion. However, in most, if not all, types of trades the identities of the parties will be revealed to the e-broker 415, which will bill the parties for its services. Such billing may be based on, for example, subscription information maintained by the e-broker 415 for each of the parties, billing information obtained from the parties prior to divulging the identity of the matching party, or at any other time prior to, during, or after the initiation of a trade.

### I. FIRST EXEMPLARY IMPLEMENTATION—CREDIT CHECKING

Most if not all types of trades need some credit checking. Any trade bid will be sent with proper cryptographic identifiers, such as provided by a Certificate Authority, and corresponding commercial identifier and level of authority of the sender or group of senders. Based on this information, the e-broker device checks credit information internally using a local database, if any, using a proper secure confidential method (in particular, the database may use one or several secure coprocessors to protect its secrecy, and communicate information only to secure e-brokers processors). Otherwise, or as a complement, the e-broker device may contact credit information companies, such as Dun and Bradstreet, using cryptographic protection of confidentiality, as is generally known in the art, and request the credit rating to be presented in some mutually agreed format, such as an Extensible Markup Language (XML) format for example.

The e-broker device may check the credit rating against the standard credit requirements of the broker, such as in the case of high volume trading. Alternatively, or in addition to this check, the credit rating may also be checked by potential counterparties to the trade. In both cases, whenever the credit is judged insufficient, the bidder may be offered the opportunity to offer collateral, to thereby change the bidder's credit rating.

With reference now to FIG. 5, an example data flow of the present invention as applied to credit checking will be described. As shown in FIG. 5, the e-broker device 510 receives, either automatically or from the owner or its agents, the description of a type of trade it will transact (520). This description consists for instance of a list of industries whose members may seek credit, the range of credit to be sought, and possibly also a list of required or preferable qualifications for credit worthiness, such as geography, assets, credit rating, and the like.

The e-broker device 510 publishes the description of the type of trade it will next transact, together with cryptographic access methods, and identification of the trade's owner and the methods it will use to determine an appropriate counterparty (530). This may be done for instance using Pub/Sub, posting on a web page, or the like.

Next, potential credit seekers that have the right qualifications receive the description of the trade as subscribers in a Pub/Sub infrastructure, by looking at a proper web page (directly or using some specialized search engine), or the like (540). The credit seekers will then respond to the posting of the description of the trade with a message indicating their intention to seek credit and the terms of their request for credit (step 550).

The e-broker device 510 then composes a description of the message, Mess1, it will broadcast to fetch counterparties willing to extend the credit sought by the credit seekers (555). For instance, this message can be composed by deleting the name and address of the credit seeker from the message the credit seeker sent to the e-broker device 510. The e-broker device 510 can optionally provide the credit seeker with an opportunity to edit and/or accept the message that is to be broadcast.

Then, the e-broker device 510 publishes the message, Mess1, after correction if needed, using again a Pub/Sub infrastructure, simple message posting, or the like, again with cryptographic access methods and description of the owner and its methods 570. Potential lenders may then send offers of credit, possibly with extra credit rating requirements, which are then passed to the credit seeker through the e-broker device (580). Time stamping can be used to determine the priority of similar offers.

The credit seeker preserves anonymity until a match is found. In some cases, the type of business that the credit seeker is in will also be kept confidential. Alternatively, the business type of the credit seeker can have limited distribution by arranging that only declared potential lenders will have access to a list of credit seekers after they declare their interest in providing the funds.

Once a matching lender is identified for a credit seeker, the two parties are provided with information regarding the other party to the trade. Such information may be of such a type as to still maintain the anonymity of the parties but provide the parties with additional information for confirming their intent to enter into the trade with the other party. Once both parties have assented to the trade, e.g., the lender agrees to provide the credit and the credit seeker agrees to the terms by which the credit will be extended, the identities of the parties may be revealed so that the trade may be completed by the parties.

### II. SECOND EXEMPLARY IMPLEMENTATION—BLOCK TRADING e-BROKERS

With block trading, the e-broker device selects a type of trade, which consists for instance of bounds (upper and lower) based on the size of the blocks, and the security or family of securities (e.g., industrial, computer industry, software companies, etc . . . ), or other instrument to be brokered. The e-broker device publishes the description of the type of trade it will next manage, together with cryptographic access methods, and pointers to its owner and the methods it will use. This will preferably be done using Pub/Sub, posting on a web page, or the like.

Interested parties may then get the description of the trade as subscribers in a Pub/Sub infrastructure, by looking at the proper web page (directly or using some specialized crawler, intelligent agent, or remote trigger as is well known in the art), or the like. The interested parties, i.e. bidders, send block trading bids together with all data as described above in the credit checking section. To avoid attacks by traffic analysis, all firms which can participate in some form of trade, and are part of the set of subscriber clients devices, may be asked to send messages regardless of whether they will be involved in the trade or not in order to make it more difficult for third parties to analyze data traffic to obtain the content of the bids. Such messages may be, for example, no-interest declarations.

Optionally, the e-broker device may then compose a description of the message it will broadcast to fetch counterparties willing to match the bid. That is, the e-broker device may wait until one offer is made and then advertise in broad terms the nature of the offer to seek for counterparties. For instance, this message composition can be generated by simply deleting the name and address of the bidder from the block trading bids while maintaining or inserting a description of the industry of the stocks involved in the trade.

One may prefer to not look for counterparties, and only expect that both sale and buy request will be sent. Whether or not counterparties will be sought is part of the description of the methods that the e-broker will make available. That is, the e-broker device may advertise a type of trade and wait until bids can be matched, i.e., the e-broker device may wait until there are both offers to sell some security S and offers to buy the same security S, there are both offers to sell some security S and offers to buy any of a list of stocks R,S,T, . . . that comprises securities S. If a message will be sent to find counterparties to the trade, the e-broker device may provide the bidder with the opportunity to edit and/or accept the message to be broadcast. In this case, the e-broker device publishes the message, after correction if needed, using again a Pub/Sub infrastructure, simple message posting, or the like, again with cryptographic access methods and pointers to the owner and methods.

Candidate counterparties may then respond to the message by sending offers of potentially matching bids, possibly with extra credit rating requirements or other types of requirements, which are then passed to the bidder. Time stamping can be used to provide a priority order for similar offers. The bidders and the counterparties preserve anonymity until a match is found whether or not the counterparties are sought by publishing the message or not.

It is advisable that all bids be binding whenever a match is found, so that pretend bidders cannot use the e-broker device to get views on the market as this would be adverse to the interests of actual bidders. If a match is found, after mutual acceptance by the bidders and the counterparties, in order to complete the trade one proceeds as usual in the industry, depending on the instrument being trade and local laws and usage.

If no match is found, the e-broker device can combine offers to make a multiparty match. For example, assume that a party offers to buy or sell units of A (where A is for instance a security or a ton of coal, etc.). There are buy offers for N1, N2, N3, . . . Nn units of A, and offers to sell for M1, M2, . . . ,Mm units of A. The e-broker device may determine if some sum Ni+Nj is equal to some sum Mk+Ml. Sums of three or 4 can also be considered, although considering all combinations may, in some cases, be computationally not feasible. The e-broker device may also handle the case when the buy offers are of the form N1 at price P1, N2 at price P2, . . . , Nn at price Pn and the sell offers are of the form M1 at price Q1, M2 at price Q2, . . . , Mm at price Qm. Looking then at matches includes looking for matches of the form Ni*Pi+Nj*Pj=Mk*Qk+M1*Q1. Moreover, instead of equalities, the e-broker can look for almost equalities if the parties know in advance that they may have to accept offers close enough to their bid in a way qualified precisely.

If still no match is found, or before trying combinations, the e-broker device may look at closest matches (using time stamping and/or credit rating to differentiate equal bids) to determine if one of the parties has indicated it may be flexible with regard to the terms of the bid or counteroffer.

For example, before beginning any negotiation, the e-broker device may ask both parties if they accept the credit rating of the potential counterparties and, as described previously, will request the parties to define how credit may be improved, if possible, to meet the requirements of the parties. Once the mutual credit rating agreement is achieved, the e-broker device may query a first party whether it accepts the offer of the second party. If the answer is yes, a match is found and one proceeds as usual.

Otherwise, if the second party has indicated that it is flexible, the second party is offered the bid of the first party, with the same process. If no match is found, but both parties are flexible, the e-broker device takes the arithmetic mean of the almost matching bids, and offers this new trade to both parties. If they accept, a match is found and one proceeds as usual. If no party accepts and no party proposes a bid closer to the median, the negotiation terminates, and the e-broker device looks for other matches.

A given bid will be reconsidered for matches until some predetermined time limit, or until the e-broker device decides to discontinue this type of trade. If only one of the parties accepts the median, or comes closer to it, the e-broker takes again a mean, this time between the latest positions accepted by the bidders, and proceeds the same way until either a match is found, or both parties refuse an offer composed by the e-broker device. Once in the negotiation phase, i.e., if no match is found right away from the original bids, a bidder who accepts to modify its bid may require other trades to be added as explained previously. The method of negotiation described here between two bidders can be adapted to match sets of bidders on either the sell or buy sides, each bidder of a conglomerate keeping the original proportions of the conglomerated offers, where original refers to very initial state, or for the previous state in the negotiation.

As an example of the implementation described above, consider that a first bidder Bid1 wants to sell a first quantity Q1 of stockX at a price P1, or a total money outlay of P1t=P1*Q1. A second bidder Bid2 wants to buy a second quantity Q2 of stockX at a price P2, for a total money outlay of P2t=P2*Q2. A third bidder Bid3 wants to buy a third quantity Q3 of stockX at a price P3, for a total money outlay of P3t=P3*Q3.

A virtual bidder Bidv is formed that wants to buy a quantity Qv=Q2+Q3 of stockX at a price Pv=(Q2*P2+Q3*P3)/(Q2+Q3), or a total money outlay of Pvt=Q2*P2+Q3*P3. It may be assumed that Qv<Q1, Pvt<Pit, P2<P1, and P3<P1 as this is the most difficult case. The median offer is defined as a quantity Qm=(Qv+Q1)/2 of stockX at a median price of Pm=(Pv+P1)/2, with a total median monetary outlay of Pmt=Qm*Pm.

In such a case, the e-broker device will offer:

1) Bid1 to sell Qm stocks at Pm,

2) Bid2 to buy Q2*Qm/(Q2+Q3) for P2t*Pmt/(P2t+P3t), i.e., at P2t*Pmt (Q2+Q3)/Q2*Qm (P2t+P3t),

3) Bid3 to buy Q3*Qm/(Q2+Q3) for P3t*Pmt/(P2t+P3t), i.e., at P3t*Pmt (Q2+Q3)/Q3*Qm (p2t+P3t).

The last positions accepted by the bidders can be chosen as the new initial stages, and the negotiation continues until a match is found or no trade is accepted. A minimal required change in the positions of the bids may be required in order to ensure convergence.

### III. THIRD EXEMPLARY EMBODIMENT—HIGH-VOLUME TRADING e-BROKERS

The e-broker device selects a type of trade, which consists for instance of bounds (upper and lower) on the size of the blocks, and the security or family of securities (e.g., industrial, computer industry, software companies, etc . . . ), or other instrument to be brokered. The e-broker device publishes the description of the type of trade it will next take care of, together with cryptographic access methods it will use. This will preferably be done using Pub/Sub, posting on a web page, or the like.

Interested parties obtain the description of the trade as subscribers in a Pub/Sub infrastructure, by looking at the proper web page (directly or using some specialized crawler as above), or the like. These parties may then send block trading bids together with all data as described above in the credit checking section. Time stamping will preferably be used to order similar offers in a priority order, as explained previously. The time stamping devices will preferably be scattered so that every bidder is close to a time stamping machine.

It is advisable that all bids be binding whenever a match is found (possibly within some time limit), so that pretend bidders cannot use the e-broker devices to get views on the market as this would be adverse to the interests of actual bidders. The rest of the process goes as usual and the identity of bidders will be kept secret until a match is found. By maintaining the identity of the bidders secret, any biases against bidders may be effectively eliminated. For example, in several trades going on presently through human brokers, the parties are unknown to each other until a match, or some time even a good chance for a match is found, at which stage, the parties identity is revealed to each other (and in some cases, the parties finish the deal directly). If one party misbehaves too often at this stage, its identity is soon known in the business and no reasonable broker takes his/her bids nor offers him/her trades any more. The broker may also automatically exclude the party.

In case of a do or kill, i.e. a bid that is canceled all together if not satisfied, which is not matched, or in other case of no match, whether or not the bidder is charged for services anyhow, its bid may still be guaranteed to be kept secret.

For very high volumes, actual matches may also be performed anonymously in a larger computer associated with the e-broker device. For example, each bid may be sent to this larger computer by the e-broker device (many e-broker devices may serve the same large computer) or similarly secure box (which may be integrated in the larger computer, such as in some IBM 390 mainframe computers), together with an encrypted version of the bidder's identity and the identity of the sending e-broker device. Decryption of the bidder's identity will not be performed before a match is found or it has been determined that the bid is obsolete.

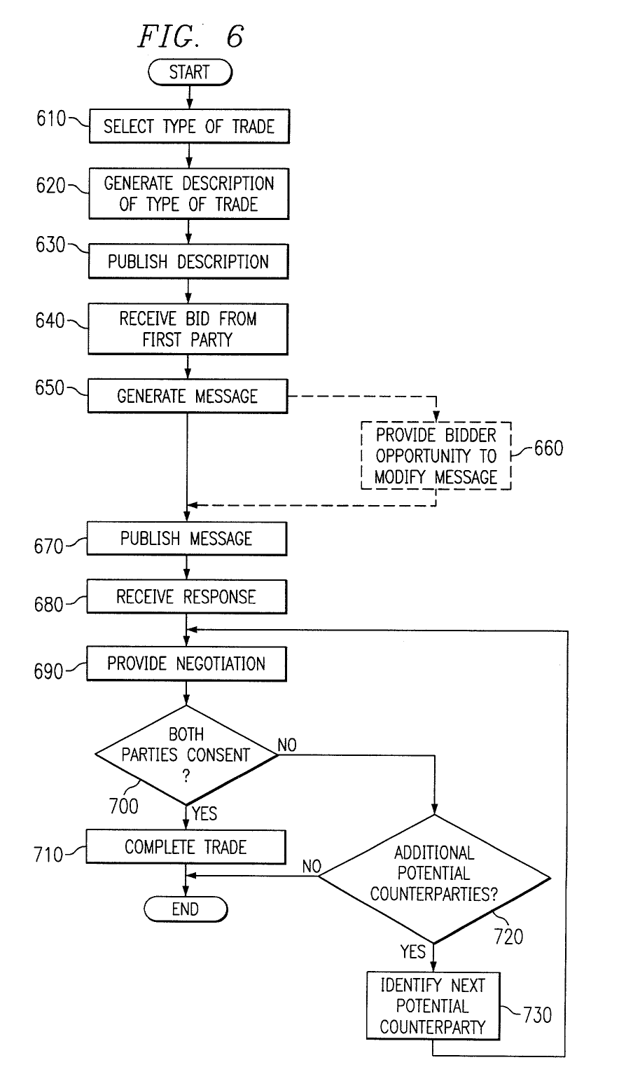

FIG. 6 is a flowchart outlining an exemplary operation of the present invention. As shown in FIG. 6, the operation starts with a selection of a type of trade to be next managed by the e-broker device (step 610). A description of the trade is generated (step 620) and published (step 630). A bid is received from a first party indicating the requirements of the trade that the bidder wishes to make (step 640). The e-broker device generates a message identifying the requested trade (step 650). Optionally, the bidder is provided with an opportunity to approve and/or modify the message (step 660). The e-broker device then publishes the message (step 670). A response is then received from one or more potential counterparties which may include a counteroffer or counter bid (step 680).

The e-broker device then facilitates negotiation between the two parties (step 690) in the manner described above. A determination is made as to whether both parties consent to the trade terms (step 700). If so, the trade is completed in a customary fashion (step 710). Otherwise, a determination is made as to whether there are any additional potential matching counterparties (step 720). If there are additional potential matching counterparties, a next potentially matching counterparty is identified (step 730) and the operation returns to step 690. If no other potential counterparties are present, the trade fails and the operation ends.

Thus, the present invention provides an e-broker device that is capable of providing brokerage services using secure communication by using various forms of digital signatures and authentication procedures to maintain the integrity of the e-broker device. In addition, the present invention provides an e-broker device in which there is very high confidentiality about the nature of the trades being made, as well as about the parties that make or seek deals. The present invention maintains a high level of confidentiality by either completely maintaining the identities of the parties confidential with regard to other parties or by limiting the distribution of identification information to parties that have demonstrated an verified interest in participating in the trade.

The present invention further provides a fair process by which parties may complete a trade by allowing parties to designate requirements for completing the trade, their flexibility with regard to terms of the trade, and providing the parties with opportunity to make counteroffers or counter bids. The present invention further provides e-broker devices that offer services comparable to those offered by human agents and Which are relatively inexpensive to manufacture and maintain even when the needs for different kinds of electronic brokering arises. The present invention provides a relatively inexpensive solution in that the e-broker devices themselves are field programmable and able to be reprogrammed to handle various types of trades with minimal downtime.

When using messaging middleware for the communications in all examples, one could use very scalable Pub/Sub, such as Gryphon, for the advertising and information distribution functions, and very reliable messaging with persistence and guaranteed deliver, such as MQSI as sold by the IBM corporation, for transaction processing and/or to submit proposals. In some cases weaker forms of messaging such as subject base messaging (e.g., Rendez Vous from TIBCO) can be used either to solve the entire problem or a restricted version of it.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. For example, as mentioned previously, several other types of trades other than credit checking and security trading may be brokered by the e-broker device according to this invention without departing from the spirit and scope of the present invention. Moreover, instead of exchange type matching, as in high volume trading, or one-to-one matching as in credit and block trading, the e-broker can use any form of an auction to find matches between parties to a trade. In addition multi-part (also called multi-legged) trades may be accomplished by the present invention where, for example, a common stock and an option or multiple options can be traded as a single security simultaneously or according to a schedule dependent on other variables such as price and size or volume.

The embodiments were chosen and described in order to best explain the principles of the invention, the practical application, and to enable others of ordinary skill in the art to understand the invention for various embodiments with various modifications as are suited to the particular use contemplated.

What is claimed is:

1. A method of electronic brokering in a data processing system, comprising:
publishing, over the data processing system, a type of trade that is to be brokered;
receiving a bid from a first party corresponding to the type of trade; and
publishing, over the data processing system, criteria for a matching bid without compromising an identity of the first party.

2. The method of claim 1, wherein publishing a type of trade that is to be brokered includes publishing one or more of a list of acceptable parties to the trade, the type of trade, and a list of preferable qualifications for performing the type of trade.

3. The method of claim 1, further comprising publishing one or more of cryptographic access methods to be used and methods that will be used to determine an appropriate counterparty.

4. The method of claim 1, wherein publishing a type of trade that is to be brokered includes publishing the type of trade using Pub/Sub messaging.

5. The method of claim 4, wherein the Pub/Sub messaging is performed using messaging middleware.

6. The method of claim 1, further comprising providing the criteria for a matching bid to the first party prior to publishing the criteria for the matching bid.

7. The method of claim 1, wherein publishing a type of trade that is to be brokered includes publishing the type of trade using message posting.

8. The method of claim 1, further comprising receiving a counterparty bid from a second party in response to the publishing of the criteria for a matching bid.

9. The method of claim 8, wherein the counterparty bid includes additional requirements to be met by the first party.

10. The method of claim 8, further comprising presenting the counterparty bid to the first party without compromising an identity of the second party.

11. The method of claim 10, wherein the identity of the first party is disclosed to the second party and the identity of the second party is disclosed to the first party only when both the first party and the second party indicate intent to complete the trade.

12. The method of claim 1, further comprising:
obtaining credit information of the first party; and
Comparing the credit information to credit requirements

13. The method of claim 12, further comprising providing the first party with an opportunity to offer collateral if a result of comparing the credit information to the credit requirements is that the credit information is insufficient.

14. The method of claim 1, wherein the electronic brokering is electronic brokering of a request for credit.

15. The method of claim 1, wherein the electronic brokering is electronic brokering of block trades.

16. The method of claim 1, wherein the electronic brokering is electronic brokering of high volume trades.

17. The method of claim 8, further comprising determining if the counterparty bid matches requirements of the bid from the first party.

18. The method of claim 17, further comprising determining if a combination of counterparty bids matches the requirements of the bid from the first party, if the counterparty bid does not match the requirements of the bid from the first party.

19. The method of claim 17, further comprising:
determining a mean bid from the bid from the first party and the counterparty and presenting the mean bid to the first party and the second party, if the counterparty bid does not match the bid from the first party.

20. The method of claim 1, wherein the method is implemented in a field programmable device.

21. The method of claim 1, wherein the method is implemented in an IBM 4758 PCI Cryptographic Coprocessor.

22. The method of claim 1, wherein the method is implemented in a processor having a cryptographic coprocessor.

23. An electronic brokering apparatus, comprising:
means for publishing, over the data processing system, a type of trade that is to be brokered;
means for receiving a bid from a first party corresponding to the type of trade; and
means for publishing, over the data processing system, criteria for a matching bid without compromising an identity of the first party.

24. The electronic brokering apparatus of claim 23, wherein publishing a type of trade that is to be brokered includes publishing one or more of a list of acceptable parties to the trade, the type of trade, and a list of preferable qualifications for performing the type of trade.

25. The electronic brokering apparatus of claim 23, further comprising means for publishing one or more of cryptographic access methods to be used and methods that will be used to determine an appropriate counterparty.

26. The electronic brokering apparatus of claim 23, wherein the means for publishing a type of trade that is to be brokered includes means for publishing the type of trade using Pub/Sub messaging.

27. The electronic brokering apparatus of claim 26, wherein the means for publishing the type of trade using Pub/Sub messaging is messaging middleware.

28. The electronic brokering apparatus of claim 23, further comprising means for providing the criteria for a matching bid to the first party prior to publishing the criteria for the matching bid.

29. The electronic brokering apparatus of claim 23, wherein the means for publishing a type of trade that is to be brokered includes means for publishing the type of trade using message posting.

30. The electronic brokering apparatus of claim 23, further comprising means for receiving a counterparty bid from a second party in response to the publishing of the criteria for a matching bid.

31. The electronic brokering apparatus of claim 30, wherein the counterparty bid includes additional requirements to be met by the first party.

32. The electronic brokering apparatus of claim 30, further comprising means for presenting the counterparty bid to the first party without compromising an identity of the second party.

33. The electronic brokering apparatus of claim 32, wherein the identity of the first party is disclosed to the second party and the identity of the second party is disclosed to the first party only when both the first party and the second party indicate intent to complete the trade.

34. The electronic brokering apparatus of claim 23, further comprising:
means for obtaining credit information of the first party; and
means for comparing the credit information to credit requirements.

35. The electronic brokering apparatus of claim 34, further comprising means for providing the first party with an opportunity to offer collateral if a result of comparing the credit information to the credit requirements is that the credit information is insufficient.

36. The electronic brokering apparatus of claim 23, wherein the electronic brokering apparatus brokers a request for credit.

37. The electronic brokering apparatus of claim 23, wherein the electronic brokering apparatus brokers block trades.

38. The electronic brokering apparatus of claim 23, wherein the electronic brokering apparatus brokers high volume trades.

39. The electronic brokering apparatus of claim 30, further comprising means for determining if the counterparty bid matches requirements of the bid from the first party.

40. The electronic brokering apparatus of claim 39, further comprising means for determining if a combination of counterparty bids matches the requirements of the bid from the first party, if the counterparty bid does not match the requirements of the bid from the first party.

41. The electronic brokering apparatus of claim 39, further comprising:
means for determining a mean bid from the bid from the first party and the counterparty and presenting the mean bid to the first party and the second party, if the counterparty bid does not match the bid from the first party.

42. The electronic brokering apparatus of claim 23, wherein the electronic brokering apparatus is implemented in a field programmable device.

43. The electronic brokering apparatus of claim 23, wherein the electronic brokering apparatus is implemented in an IBM 4758 PCI Cryptographic Coprocessor.

44. The electronic brokering apparatus of claim 23, wherein the electronic brokering apparatus is implemented in a processor having a cryptographic coprocessor.

45. A computer program product in a computer readable medium for electronic brokering in a data processing system, comprising:
first instructions for publishing, over the data processing system, a type of trade that is to be brokered;
second instructions for receiving a bid from a first party corresponding to the type of trade; and
third instructions for publishing, over the data processing system, criteria for a matching bid without compromising an identity of the first party.

46. The computer program product of claim 45, wherein the first instructions for publishing a type of trade that is to be brokered include instructions for publishing the type of trade using Pub/Sub messaging.

47. The computer program product of claim 45, further comprising fourth instructions for receiving a counterparty bid from a second party in response to the publishing of the criteria for a matching bid.

48. The computer program product of claim 47, further comprising fifth instructions for presenting the counterparty bid to the first party without compromising an identity of the second party.

49. A method of initializing an electronic broker, comprising:
defining a set of rules for a type of trade;
defining a set of programs for implementing the set of rules; and
defining a set of signatures for programs that may provide instructions to the electronic broker.

50. The method of claim 49, wherein the set of rules includes one or more of a matching method, a negotiation scheme, and operating rules for the electronic broker.

51. The method of claim 49, wherein the set of programs is stored in a storage device associated with the electronic broker in an encrypted form.

52. The method of claim 49, further comprising storing a signature for each program in the set of programs in memory.

53. The method of claim 49, wherein the electronic broker only accepts trades of a type that may be brokered in conjunction with already active trades.

54. The method of claim 49, wherein the electronic broker only accepts inputs pertaining to elements of a trade or security measures of a trade.

55. The method of claim 54, wherein the inputs pertaining to elements of a trade include one or more of requests from an owner of the electronic broker for a list of signatures of programs that the electronic broker may run for different trades, offers of trades, information sheets, acceptances or rejections of offers, demands for change of offers if an original offer is not met, and queries for mutual revelation of identity and/or contact information from parties that have matching bids.

56. The method of claim 54, wherein the inputs pertaining to security measures of a trade include one or more of encrypted versions of party names after a match of bids has been made, signature methods being used by the electronic broker, encryption methods being used by the electronic broker, and format being used by the electronic broker.
